(19) United States
(12) Patent Application Publication
(10) Pub. No.: US 2015/0082876 A1
(43) Pub. Date: Mar. 26, 2015

(54) EXCAVATOR SELF-DETECTION SYSTEM AND METHOD

(71) Applicants: Chuanbao Zhu, Kunshan (CN); Xiaodan Tu, Shanghai (CN); Yuan Deng, Shanghai (CN)

(72) Inventors: Chuanbao Zhu, Kunshan (CN); Xiaodan Tu, Shanghai (CN); Yuan Deng, Shanghai (CN)

(73) Assignees: SANY HEAVY MACHINERY LIMITED, Jiangsu (CN); SHANGHAI HUAXING DIGITAL TECHNOLOGY CO., LTD, Shanghai (CN)

(21) Appl. No.: 14/240,091

(22) PCT Filed: Apr. 19, 2012
(86) PCT No.: PCT/CN2012/074338

§ 371 Date: Nov. 3, 2014

(30) Foreign Application Priority Data
Aug. 22, 2011 (CN) 201110241263.8

(51) Int. Cl. G01F 9/00; G08B 21/24; G01M 15/04

(52) U.S. Cl. CPC G01F 9/00; G01M 15/042; G08B 21/24
USPC 73/114.53

(57) ABSTRACT

An excavator self-detection system comprises a controller, a fuel inlet flow meter, a fuel outlet flow meter and a performance self-detection controller. The fuel inlet flow meter and the fuel outlet flow meter are deployed at a fuel inlet and a fuel outlet of an engine respectively, and are connected to the performance self-detection controller. The performance self-detection controller is connected to the controller. The performance self-detection controller reads the signal values of the fuel inlet flow meter and the fuel outlet flow meter, calculates a fuel consumption value, and reads a machine parameter of the excavator through the controller to determine the performance. A detection method is also provided which uses the above excavator self-detection system. The method comprises performance self-detection, a fuel consumption test, and an efficiency test. The measuring equipment can be set by itself according to different machine types and different communication protocols. The detection device of the present invention aims to the different excavators with different communication protocols setting, therefore it owns strong portability. The condition of people waste is effectively reduced, and by means of the self-detection function, the measurement precision is improved.

### CROSS-REFERENCE TO RELATED APPLICATIONS

The present application claims the priority of the Chinese application number 201110241263.8, filed on Aug. 22, 2011, the disclosure of which is herewith incorporated by reference in its entirety.

### TECHNICAL FIELD

The present invention relates to a detection system and the method thereof, more specifically, to an excavator for self-testing system and the method thereof.

### BACKGROUND OF THE INVENTION

The excavator performance mainly depends on the fuel consumption and the excavation efficiency and excavation force etc, wherein, the fuel consumption test is extremely important when the excavators are launched in the market or during the subsequent upgrade process.

In the aspect of fuel consumption, the traditional fuel consumption tests generally require the machine operator, the fueling operator and the on-site counting person etc. to participate together in the process. The specific process comprises the following steps the testers fill the tank at first, then the test is performed and to the machine is stopped after the prescribed time, afterwards the testers fill up the tank again, the fuel consumption data is finally calculated based on the fuel compensation. The whole process requires a lot of manpower and resources. Additionally, the machine may be tested under an abnormal condition since that the operator is uncertain about the machine parameters. For instance, the repeated rotation and shaking operation is required for avoiding the air leaking of the oil channel. If the operation is incomplete, the accuracy of the test data may be influenced. In the aspect of the excavation efficiency testing, the well cooperation between the operators and the counting person is required. A horn is adopted as a signal for the initial condition, then the counter person begin to calculate and remind the operator about the end time. The process is complicated. Meanwhile the counting result may be inaccurate due to the counting person's negligence.

### SUMMARY OF THE INVENTION

Regarding to the above problems, an object of the present invention is to provide an excavator self-detection system and method for excavator, which mainly uses the measuring apparatus to perform a self-detection on the machine performance, to measure the fuel consumption data automatically. It may achieves an accurate measurement results, and saves lots of manpower. It also owns the feature of small size and easy installation.

The object of the present invention is achieved by the following technical solutions:

An excavator self-detection system is provided, wherein it comprises a controller, a fuel inlet flow meter, a fuel outlet flow meter and a performance self-detection controller, the fuel inlet flow meter and the fuel outlet flow meter are deployed at a fuel inlet and a fuel outlet of an engine respectively, and connected to the performance self-detection controller, the performance self-detection controller is connected to the controller; the performance self-detection controller reads the signal values of the fuel inlet flow meter and the fuel outlet flow meter, calculates a fuel consumption value, and reads a machine parameter of the excavator through the controller to determine the performance.

According to the above excavator, wherein the self-detection controller is connected to the controller via a CAN-bus.

A self-detection method is provided, using the above mentioned excavator self-detection system, wherein it comprises overall performance self-detection, fuel consumption test, and efficiency test, wherein:

the overall performance self-detection comprises the following steps:

providing several switch variables for storing different determination values, the determination values comprise the single-motion time, the rotational speed, the current and the voltage;

performing the test for single-motion time, which comprises that: the performance self-detection controller determines whether the single-motion of the excavator is generated, if so, timing the single-motion of the excavators from its start to its stop; comparing the clocked time and the pre-stored data in the controller, if the standard is reached, the corresponding switch goes to “0”, if not, the corresponding switch goes to “1”;

performing the tests for the rotational speed, the current or the voltage of the excavator self-detection system, it comprises that: shifting to the required gear, and determining whether the main voltage is greater than the preset main voltage, if so, the performance self-detection controller compares the received values of the excavator speed, current, and voltage with the pre-stored data in the controller, if the standard is reached, the corresponding switch variable goes to “0”, if not, the corresponding switch variable goes to “1”;

merging all the switch variables into integer quantity, and generating synthetic fault code.

The fuel consumption test comprises the following steps: the performance self-detection controller calculates the fuel inlet and fuel outlet data upon the feedback signal of the fuel inlet flow meter and the fuel outlet flow meter within a predetermined time, then to calculate the differential and to obtain the fuel consumption within the predetermined time;

the efficiency test comprises the following steps:

the performance self-detection controller initiates the timing operation, when the rotation motion is detected and the rotation weight is greater than the preset rotation weight value, the delay process is performed, the counting is started after the delay process so as to prevent the timing caused by the misoperation; after the test is started, the chronopher rings every 5 minutes as an calling operation and rings frequently in the 30 seconds before the end of the ringing so as to remind the operator the time is up;

the measurements of the fuel test controller remains unchanged after the set unit time is up.

According to the self-detection method using the excavator self-detection system, wherein the amount of the several switch variables is sixteen, which represent different single motion determination values.

According to the self-detection method using the excavator self-detection system, wherein the preset value of the main voltage is 34.3 MPa.

According to the self-detection method using the excavator self-detection system, wherein the chronopher is a buzzer.

According to the self-detection method using the excavator self-detection system, wherein the preset rotation weight value is 5 kg.

According to the self-detection method using the excavator self-detection system, wherein if the rotation weight is greater than the preset value, the delay time of the delay process is 30 ms.

In comparison with the prior arts, the beneficial effects of the present invention are as follows:

(1) the measuring device for different models with different communication protocols can be self-set themselves with high portability;

(2) the labor costs are reduced, self-detection function is employed for improving the measurement accuracy. Meanwhile, the necessary solution is provided for the outdoor serve staff and performance test in the early stage.

### BRIEF DESCRIPTION OF THE DRAWINGS

FIG. 1 shows a structure diagram of the system in the present invention; FIG. 2 shows an assembling diagram of the fuel outlet flow meter and fuel inlet flow meter;

FIG. 3a shows a time test flow chart of the present invention;

FIG. 3b shows the tests of the excavating speed, the dropping speed, the current, the voltage in the present invention;

FIG. 3c shows the fuel consumption flow chart of the present invention; FIG. 3d shows the test flow chart of the present invention.

### DESCRIPTION OF THE PREFERRED EMBODIMENT

The present invention will be further illustrated in combination with the following Figures and embodiments. However, it should not be deemed as limitations of the present invention.

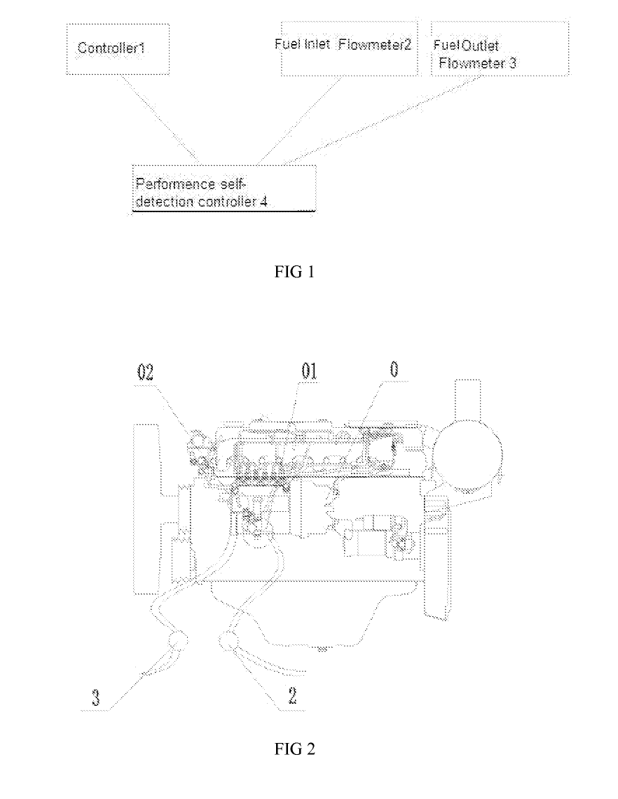

As referred in FIGS. 1 and 2, the present invention discloses an excavator self-detection system, which comprises a controller 1, a fuel inlet flow meter 2, a fuel outlet flow meter 3 and a performance self-detection controller 4. The fuel inlet flow meter 2 and the fuel outlet flow meter 3 are deployed at a fuel inlet 01 and a fuel outlet 02 of an engine 0 respectively, and they are connected to the performance self-detection controller 4. The performance self-detection controller 4 is connected to the controller 1. The performance self-detection controller 4 reads the signal values of the fuel inlet flow meter 2 and the fuel outlet flow meter 3 to calculate a fuel consumption value, and it reads machine parameters of the excavator through the controller 1 to determine the performance.

Furthermore, the self-detection controller 4 is connected to the controller 1 via a CAN-bus and is capable of receiving all the operating information and the machine configuration information. CAN-bus, i.e., Controller Area Network is a multi-mode serial bus. The basic design specification requires a high bit rate, high resistance to electromagnetic interference, and it can detect any occurred errors. When the signal transmission distance goes up to 10 Km, the CAN-bus can still provide the data transfer rate up to 5 Kbps.

The present invention also discloses a self-detection method using the excavator self-detection system, which mainly comprises overall performance self-detection, a fuel consumption test, and an efficiency test, wherein:

the overall self-detection performance comprises the following steps:

providing several switch variable for storing different determination value, the determination value comprises the single-motion time, speed, current, and voltage. The amount of the switch variable is sixteen, which represents to different single motion determination value, each of the switch variable means:

ErrorCode.1: the time determination value of the movable arm raising motion;

ErrorCode.2: the time determination value of the bucket rod excavating motion;

ErrorCode.3: the time determination value of the bucket rod unloading motion;

ErrorCode.4: the time determination value of the bucket excavating motion;

ErrorCode.5: the time determination value of the bucket unloading motion;

ErrorCode.6: the time determination value of the walking motion;

ErrorCode.7: the determination value of the rotation motion;

ErrorCode.8: the determination value of H11 pressure dropping speed;

ErrorCode.9: the determination value of H11 pressure voltage and current;

ErrorCode.10: the determination value of S10 pressure voltage and current speed;

ErrorCode.11: the determination value of S10 pressure voltage and current;

ErrorCode.12: the determination value of S8 pressure voltage and current;

ErrorCode.13: the determination value of S8 idling speed;

ErrorCode.14: the determination value of S10 idling speed;

ErrorCode.15: the determination value of H11 idling speed;

ErrorCode.16: the determination value of the power supply voltage.

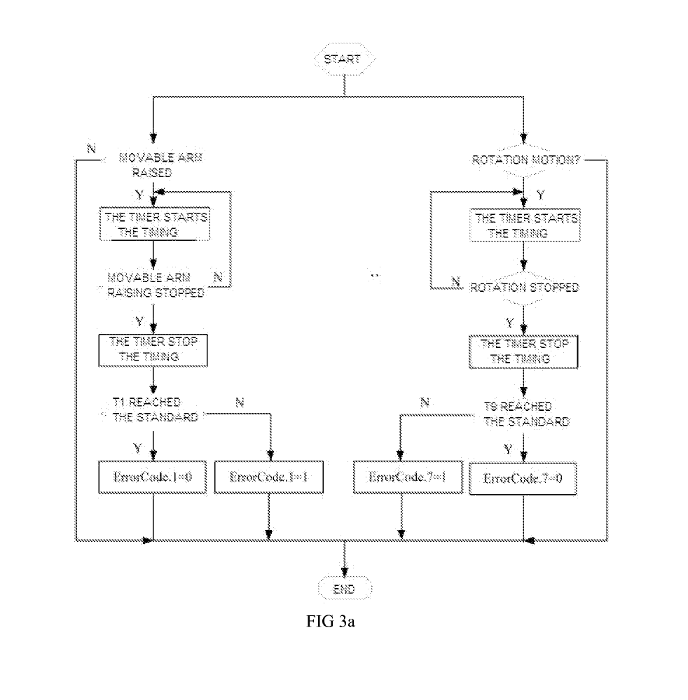

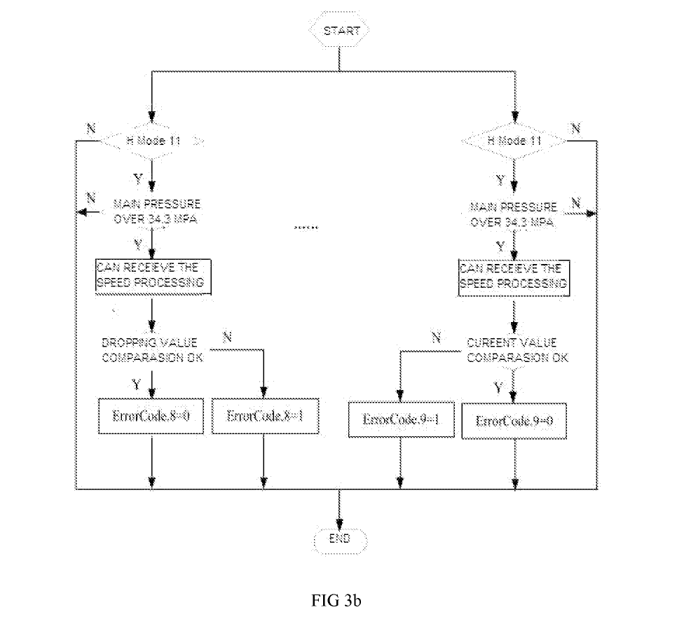

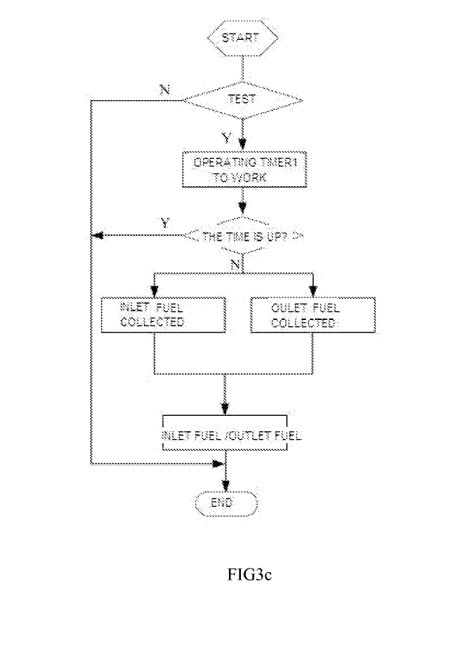

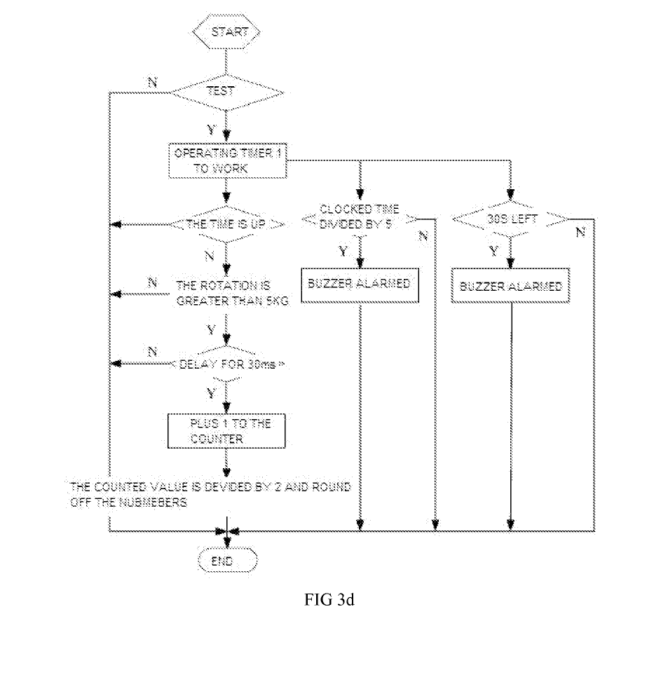

As referred in FIG. 3a, and with reference to FIGS. 1 and 2, the excavator single motion time test is performed, comprising: the operator operates the motion after they push the button, such as closing bucket rod, unload bucket rod, pressure excavator operation, the performance self-detection controller 4 determines whether the excavator single motion is generated, if so, comparing the clocked time and the pre-stored data in the controller, if the standard is reached, the corresponding switch goes to “0”, if not, the corresponding switch goes to “1”. The different single motions are corresponded to the different switch variables. For instance, lifting the movable arm which corresponds to ErrorCode 1, rotation motion corresponds to ErrorCode.7.

As referred in FIG. 3b, and with reference to FIGS. 1 and 2, the tests of the excavators speed, the dropping speed value, the current, and the voltage are performed, it comprises that: the required gear is achieved to determine whether the main pressure value is greater than its preset value, the main pressure preset value herein is 34.3 MPa. The performance self-detection controller compares the received values of the excavator speed, current, and voltage with the pre-stored data in the controller, if the standard is reached, the corresponding switch variable goes to “0”, if not, the corresponding switch variable goes to “1”. The different test objects are corresponded to the different switch variables. For instance, the determination value of the H11 pressure dropping speed corresponds to ErrorCode.8, the determination value of the H11 pressure current corresponds to ErrorCode.9. All the switch variables are merged into integer, and the synthetic fault codes are generated as follows:

| | | | | | | | |
|---|---|---|---|---|---|---|---|
| ErrorCode.1 | ErrorCode.2 | ErrorCode.3 | ErrorCode.4 | ErrorCode.5 | ErrorCode.6 | ErrorCode.7 | ErrorCode.8 |
| ErrorCode.9 | ErrorCode.10 | ErrorCode.11 | ErrorCode.12 | ErrorCode.13 | ErrorCode.14 | ErrorCode.15 | ErrorCode.16 |

If the standard is reached, i.e., if the machine performance is fine, the message “the machine performance is fine, the test can be performed” will displays in a way of message box. If one or more item is disqualified, the message “the excavator performance test is failed, the Error code is: ****, please check the machine!”. The operator will do the troubleshooting based on the fault code. For improving the universality of the control device, the standard value of each detection item and the received data ID can be rewritten by the performance self-detection controller, so that the controller received data ID can be set to communicate with the controllers in the different communication protocols even with different excavators, as long as the bus ID is detected by P-CAN. Its portability is relatively high. After the received data is converted into integer from bytes through the process, it is sequentially transferred to the array with 48 elements. And the user will reset the array index according to the ID and the specific bytes position. The detection performance standards of the system are different for the excavators with different tonnage. Therefore, the present invention determines the set function of the test standard and reset the standard data.

As referred in FIG. 3c, and with reference to FIGS. 1 and 2, the fuel consumption test comprises the following steps: the performance self-detection controller calculates the fuel inlet and fuel outlet data upon the feedback signal of the fuel inlet flow meter and the fuel outlet flow meter within a predetermined time, then to calculate the differential and to obtain the fuel consumption within the predetermined time.

As referred in FIG. 3d, and with reference to FIGS. 1 and 2, the efficiency test comprises the following steps: The performance self-detection controller 4 starts the counting operation. When the rotation motion is detected and the rotation motion is greater than the preset value 5 kg, the delay process of 30ms is performed. The count is started after the delay process. The count value is divided by two which serves as the machine efficiency in order to prevent the timing caused by the misoperation.

After the start of the test, chronopher rings every 5 minutes as a calling operation and rings frequently in the 30 seconds before the end of the ringing, so as to remind the operator the time is up.

The measurements of the fuel test controller remains unchanged after the set unit time is up. Furthermore, the chronopher is a buzzer. The buzzer is easy to obtain in the market which is beneficial to implement the present invention.

In summary, the selfdetection device and method of the present invention aim to the different excavators with different communication protocols setting, therefore it owns strong portability. The condition of people waste is effectively reduced, and the measurement precision is improved by means of the self-detection function.

While the present disclosure has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. An excavator self-detection system, wherein it comprises a controller, a fuel inlet flow meter, a fuel outlet flow meter and a performance self-detection controller, the fuel inlet flow meter and the fuel outlet flow meter are deployed at a fuel inlet and a fuel outlet of an engine respectively, and are connected to the performance self-detection controller, the performance self-detection controller is connected to the controller; the performance self-detection controller reads the signal values of the fuel inlet flow meter and the fuel outlet flow meter to calculate a fuel consumption value, and it reads machine parameters of the excavator through the controller to determine the performance.

2. An excavator as disclosed in claim 1, wherein the self-detection controller is connected to the controller via a CAN-bus.

3. A self-detection method using the excavator self-detection system as disclosed in claim 1, wherein it comprises overall performance self-detection, a fuel consumption test, and an efficiency test, wherein:
the overall performance self-detection comprises the following steps:
providing several switch variables for storing different determination values, the determination values comprise the the single-motion time, the rotational speed, the current and the voltage;
performing the test for single-motion time, which comprises that: the performance self-detection controller determines whether the single-motion of the excavator is generated, if so, timing the single-motion of the excavators from its start to its stop; comparing the clocked time and the pre-stored data in the controller, if the standard is reached, the corresponding switch goes to “0”, if not, the corresponding switch goes to “1”;
performing the tests for the rotational speed, the current or the voltage of the excavator self-detection system, it comprises that: shifting to the required gear, and determining whether the main voltage is greater than the preset main voltage, if so, the performance self-detection controller compares the received values of the excavator speed, current, and voltage with the pre-stored data in the controller, if the standard is reached, the corresponding switch variable goes to “0”, if not, the corresponding switch variable goes to “1”;
merging all the switch variables into integer quantity, and generating synthetic fault code;
the fuel consumption test comprises the following steps: the performance self-detection controller calculates the fuel inlet and fuel outlet data upon the feedback signal of the fuel inlet flow meter and the fuel outlet flow meter within a predetermined time, then to calculate the differential and to obtain the fuel consumption within the predetermined time;
the efficiency test comprises the following steps:
the performance self-detection controller initiates the timing operation, when the rotation motion is detected and the rotation weight is greater than the preset rotation weight value, the delay process is performed, the counting is started after the delay process so as to prevent the timing caused by the misoperation; after the test is started, the chronopher rings every 5 minutes as a calling operation and rings frequently in the 30 seconds before the end of the ringing, so as to remind the operator the time is up;
the measurements of the fuel test controller remains unchanged after the set unit time is up.

4. The self-detection method using the excavator self-detection system as disclosed in claim 3, wherein the amount of the several switch variables is sixteen, which represent different single motion determination values.

5. The self-detection method using the excavator self-detection system as disclosed in claim 3, wherein the preset value of the main voltage is 34.3 MPa.

6. The self-detection method using the excavator self-detection system as disclosed in claim 3, wherein the chronopher is a buzzer.

7. The self-detection method using the excavator self-detection system as disclosed in claim 3, wherein the preset rotation weight value is 5 kg.

8. The self-detection method using the excavator self-detection system as disclosed in claim 3, wherein if the rotation weight is greater than the preset value, the delay time of the delay process is 30 ms.

9. A self-detection method using the excavator self-detection system as disclosed in claims 2, wherein it comprises overall performance self-detection, a fuel consumption test, and an efficiency test, wherein:
the overall performance self-detection comprises the following steps:
providing several switch variables for storing different determination values, the determination values comprise the the single-motion time, the rotational speed, the current and the voltage;
performing the test for single-motion time, which comprises that: the performance self-detection controller determines whether the single-motion of the excavator is generated, if so, timing the single-motion of the excavators from its start to its stop; comparing the clocked time and the pre-stored data in the controller, if the standard is reached, the corresponding switch goes to “0”, if not, the corresponding switch goes to “1”;
performing the tests for the rotational speed, the current or the voltage of the excavator self-detection system, it comprises that: shifting to the required gear, and determining whether the main voltage is greater than the preset main voltage, if so, the performance self-detection controller compares the received values of the excavator speed, current, and voltage with the pre-stored data in the controller, if the standard is reached, the corresponding switch variable goes to “0”, if not, the corresponding switch variable goes to “1”;
merging all the switch variables into integer quantity, and generating synthetic fault code;
the fuel consumption test comprises the following steps: the performance self-detection controller calculates the fuel inlet and fuel outlet data upon the feedback signal of the fuel inlet flow meter and the fuel outlet flow meter within a predetermined time, then to calculate the differential and to obtain the fuel consumption within the predetermined time;
the efficiency test comprises the following steps:
the performance self-detection controller initiates the timing operation, when the rotation motion is detected and the rotation weight is greater than the preset rotation weight value, the delay process is performed, the counting is started after the delay process so as to prevent the timing caused by the misoperation; after the test is started, the chronopher rings every 5 minutes as a calling operation and rings frequently in the 30 seconds before the end of the ringing, so as to remind the operator the time is up;
the measurements of the fuel test controller remains unchanged after the set unit time is up.

10. The self-detection method using the excavator self-detection system as disclosed in claim 9, wherein the amount of the several switch variables is sixteen, which represent different single motion determination values.

11. The self-detection method using the excavator self-detection system as disclosed in claim 9, wherein the preset value of the main voltage is 34.3 MPa.

12. The self-detection method using the excavator self-detection system as disclosed in claim 9, wherein the chronopher is a buzzer.

13. The self-detection method using the excavator self-detection system as disclosed in claim 9, wherein the preset rotation weight value is 5 kg.

14. The self-detection method using the excavator self-detection system as disclosed in claim 9, wherein if the rotation weight is greater than the preset value, the delay time of the delay process is 30 ms.
